(19) United States
(12) Patent Application Publication
(10) Pub. No.: US 2018/0259767 A1
(43) Pub. Date: Sep. 13, 2018

(54) Display Module with Particulate Getter for a Near-Eye Display Device

(71) Applicant: Microsoft Technology Licensing, LLC, Redmond, WA (US)

(72) Inventors: Jeb WU, Redmond, WA (US); Andrew FULLER, Redmond, WA (US); Anthony John GRANT, Redmond, WA (US); Richard A. JAMES, Woodinville, WA (US)

(21) Appl. No.: 15/604,307

(22) Filed: May 24, 2017

Related U.S. Application Data
(60) Provisional application No. 62/470,832, filed on Mar. 13, 2017.

(51) Int. Cl. G02B 27/00; G02B 27/01; G02B 27/28; G02B 27/26

(52) U.S. Cl. CPC G02B 27/0006; G02B 27/26; G02B 27/283; G02B 27/0172

(57) ABSTRACT

An adhesive material, or “getter,” is applied to one or more interior surfaces of a display module of a near-eye display (NED) device, to act as a trap for foreign particles or debris. The display module can include a frame, a housing, and one or more display elements each to generate an image to be conveyed to an eye of a user of the NED device. The frame can have at least one surface adjacent to the image-generation surface of each display element. The display module can include an exposed layer of adhesive material covering at least a portion of each said surface within the housing.

This application claims the benefit of U.S. provisional patent application No. 62/470,832, filed on Mar. 13, 2017, which is incorporated by reference herein in its entirety.

### BACKGROUND

Virtual reality (VR) and augmented reality (AR) visualization systems have entered the mainstream consumer marketplace. These systems are typically implemented in the form of near-eye display (NED) devices, including head-mounted display (HMD) devices. The display components in these devices tend to be vulnerable to magnifying debris that manage to enter the active regions of the display. Particles as small as 50 μm or smaller can be seen by users if they come to rest on a sensitive optical element within the field of view. Keeping debris from entering the active regions of the display or cleaning the debris out of the active regions can be a difficult and costly process.

### SUMMARY

The technique introduced here includes adding a high adherent (adhesive) material, or “getter,” to one or more interior surfaces of a display module of an NED device, to act as a trap for foreign particles or debris. In certain embodiments the display module includes a frame, a housing, and one or more display elements each to generate an image to be conveyed to an eye of a user of the NED device. The frame has at least one surface adjacent to the image-generation surface of each display element. The display module further includes an exposed layer of adhesive material covering at least a portion of each said surface within the housing. The housing encloses the display element and the frame. The surfaces with the adhesive material can be side walls of the frame that are not within the optical path from the display element to the user's eyes, so the user will not see any small particles that enter the area of the active display and become trapped by the adhesive layer.

Other aspects of the technique will be apparent from the accompanying figures and detailed description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 illustrates an example of an HMD device.

FIG. 2A illustrates a side view of a display assembly of an HMD device.

FIG. 2B illustrates a front view of a display assembly of an HMD device.

FIG. 3A shows a front view of the display module.

FIG. 3B shows a side view of the display module.

FIG. 3C shows a top view of the display module.

FIG. 3D shows a back view of the display module.

FIG. 4 illustrates a perspective view of an optics assembly within the display module.

FIG. 5A shows a perspective view of a frame for holding the display elements and optical components within the display module.

FIG. 5B provides a zoomed right side view of the frame.

FIG. 6A shows a front view of the frame.

FIG. 6B shows a full-length left side view of the frame.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

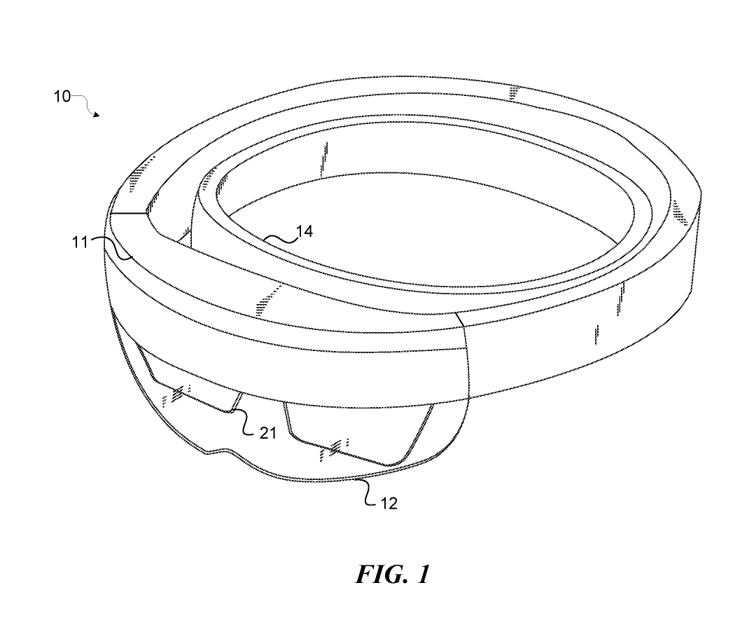

The technique introduced here can be implemented in an NED device, such as an HMD device, although it is not limited to such applications. To facilitate understanding, this description focuses on applying the technique in an HMD device. FIG. 1 shows an example of an HMD in which the technique can be implemented.

The HMD device 10 includes a chassis 11, a protective sealed visor 12, an adjustable headband (or other type of head fitting) 14, and a display assembly 17 (shown partially obscured). In certain embodiments, the headband 11, visor 12 and display assembly 17 are all attached to the chassis 11. Various sensors and electronics (not shown) may also be mounted on the chassis, including one or more processors to control operation of the NED display device, generate image data, etc.

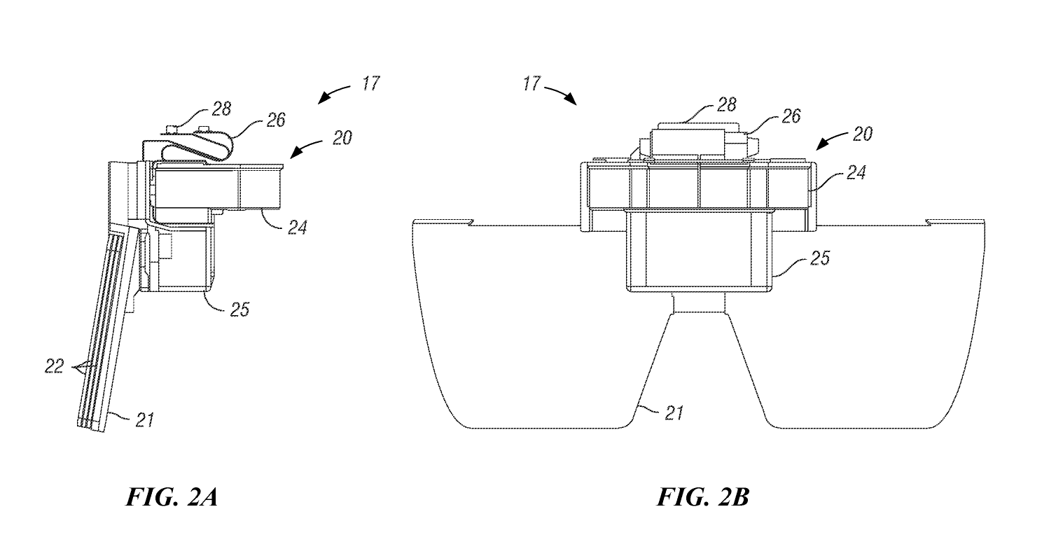

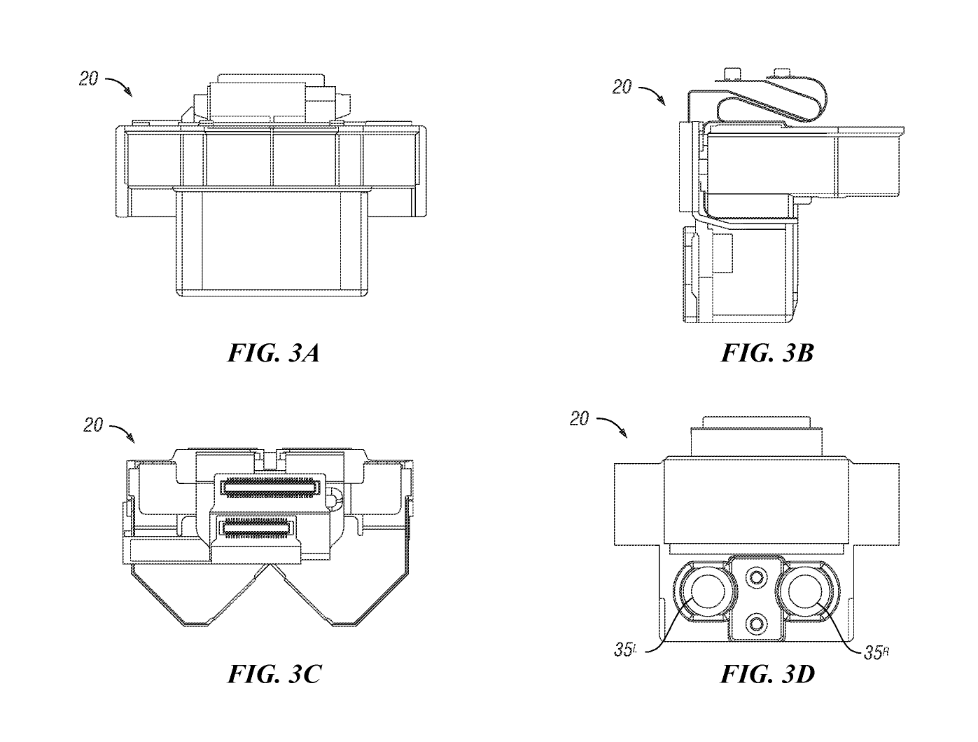

FIGS. 2A and 2B show orthogonal left side and front views, respectively, of an illustrative embodiment of the display assembly 17. The display assembly 17 is designed to overlay generated images on the user's view of his real-world environment, e.g., by projecting light into the user's eyes. The display assembly 17 includes a display module 20, a waveguide carrier 21 and one or more waveguides 22. The display module 20 houses the light sources, display elements, and optical components such as one or more lenses, mirrors and/or polarizing beam splitters (PBS). In the illustrated embodiment, the light sources are contained within the horizontally protruding portion 24 of the display module 20, while the display elements and passive optical components are housed within the vertical portion 25 of the display module 20. FIGS. 3A, 3B, 3C and 3D show, respectively, front, side, top and back orthogonal views of the display module 20.

The waveguides 22 can include separate red, green and blue waveguides for each of the left and right eyes. Left and right optical output ports 35L and 35R (FIG. 3D) in the housing of the display module 20 are optically coupled respectively to left and right optical input ports (not shown) of the waveguides 22.

In the illustrated embodiment, the waveguide carrier 21 serves as a mounting structure for the waveguides 22 and the display module 20, by to attach these components to the chassis 11 (FIG. 1). In the illustrated embodiment, the display assembly also includes flex circuit 56, one end of which is electrically coupled to the display elements and light sources within the display module 20, and which includes connectors 58 for connection to external electronics and power source (not shown) of the HMD device.

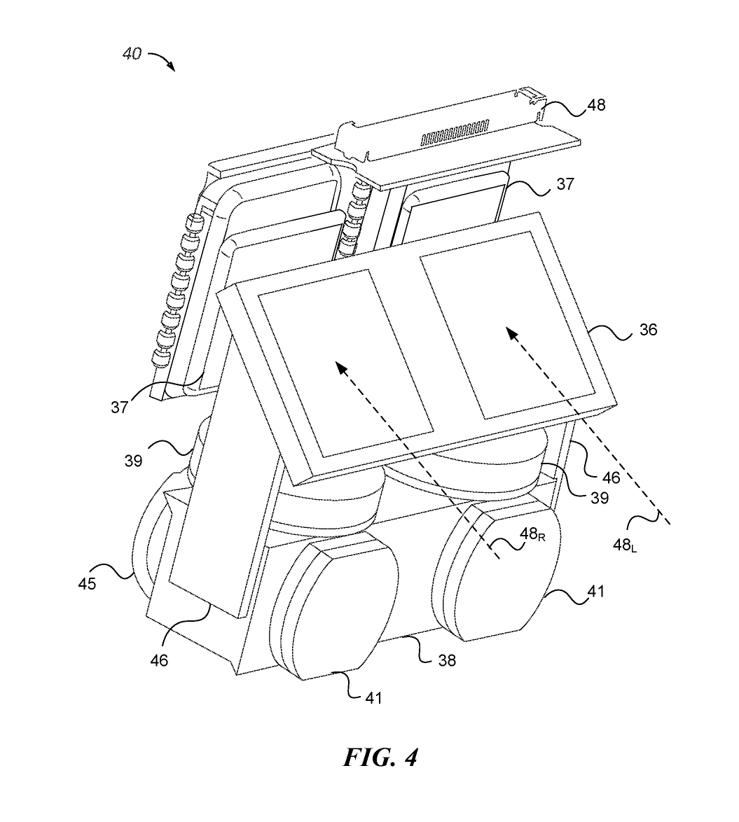

The display module 20 can include an optics assembly such as shown in FIG. 4. Arrows 48L and 48R indicate the direction of incident light originating from left and right light sources (not shown), respectively. The optics assembly 40 includes a birdbath PBS 38 coupled to a wire grid PBS 36 by two frame members 46. As shown, the frame members 46 can be coupled to the opposing small sides of the birdbath PBS 38 at one end, and to a “downstream” surface (not visible in FIG. 4) of the wire grid PBS 36 at the other end. In some embodiments, the birdbath PBS 38 and frame members 46 are formed from the same material, such as optical grade glass. Such a construction helps to avoid relative movement between components that could otherwise result from a mismatch in their thermal expansion characteristics. FIG. 4 further shows an example of the spatial relationships between the above-mentioned components and the display elements 37 and various lenses 39, 41 and 45. Additionally, an electrical connector 48 is coupled to the display elements to provide an electrical control interface for the display elements.

Each display element 37 can be, for example, a liquid crystal on silicon (LCOS) micro-display, digital light processing (DLP) display, Micro-Electro-Mechanical System (MEMS) display, liquid crystal display (LCD), or any other known or convenient type of display element. Each display element 37 is controlled by image generation electronics (not shown) to reflect or absorb selectively different portions of light incident upon its image-generation surface (from a light source in the display module 20), to produce an image.

During operation, light from a light source passes through the wire grid PBS 36 and hits the image-generation surface of a display element 37. Portions of the light incident upon the image-generation surface of the display element 37 are selectively reflected by the image-generation surface back toward the wire grid PBS 36 and then reflected downward by the wire grid PBS 36 into the birdbath PBS 38. Within the birdbath PBS 38, the light is reflected and has its polarization altered one or more times, and subsequently exits the optics assembly at an output port 45, which corresponds to output port 35L or 35R in FIG. 3D.

The display components within display module 20, particularly the display elements 37, tend to be vulnerable to magnifying debris that manage to enter the active regions of the display. Particles as small as 50 μm or smaller can be seen by users if they come to rest on or near the image generation surface of a display element 37. However, keeping debris from entering the display module 20 or removing debris from it can be a very costly process.

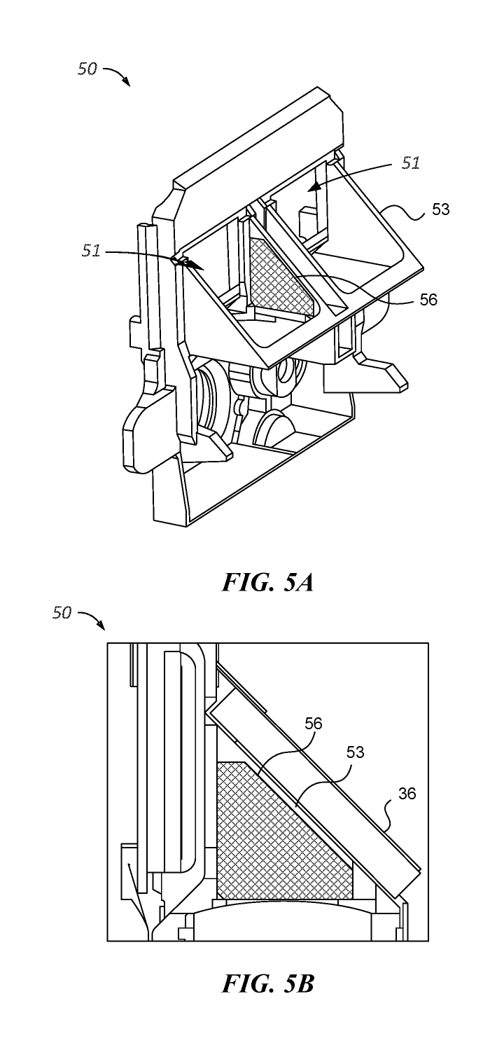

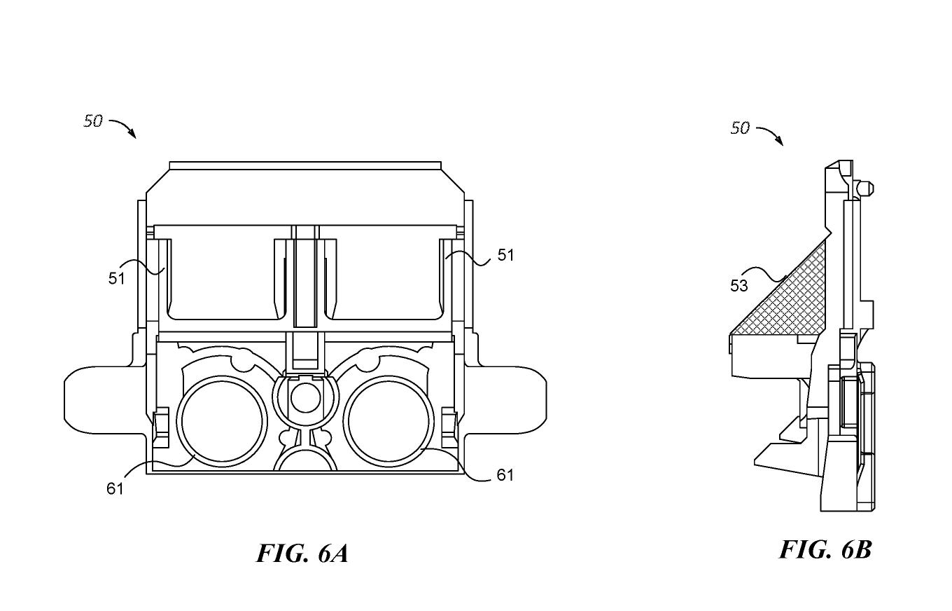

Accordingly, the technique introduced here includes adding a high adherent (adhesive) material, or “getter,” to one or more interior surfaces of a display module of an NED device, to act as a trap for foreign particles or debris. FIGS. 5A through 6B illustrate an example embodiment in which this is done. More specifically, these figures show different views of a frame 50 for holding the display elements and optical components within the display module 20. In particular, FIG. 5A shows a perspective view of the frame 50, from approximately the same viewing angle as in FIG. 4. FIGS. 6A and 6B show a full-length front and right-side views, respectively, of the frame 50, according to at least one embodiment. The frame 50 can be used with the optics assembly 40 shown in FIG. 4, although it is not shown in FIG. 4 in order to better depict the optical components.

The frame 50 has two rectangular apertures 51, each sized and shaped to correspond to mate with one of the display elements 37 (not shown) just around its image-generation surface. The frame 50 further has two circular apertures 61 (FIG. 6A) that align with corresponding circular apertures in the housing of the display module 20, to accommodate output port lenses 45 (FIG. 4) and define the optical output ports 35L and 35R (FIG. 3D).

The front side of the frame 50 has four flat, roughly triangular side walls 53, or panels (two around each of the rectangular apertures), protruding perpendicular to the image-generation surface of the display elements 37. The side walls 53 provide isolation between the left and right optical paths. The front edges 55 of the four side walls 53 have an acute angle relative to the image-generation generation surfaces of the display elements and collectively provide a mounting surface for the wire grid PBS 36 (FIG. 4). FIG. 5B provides a zoomed side cross-sectional view showing how the PBS 36 can be mounted to the side walls 53.

In accordance with the technique introduced here, a layer 56 of adhesive material is applied to the major flat surface of at least one side wall 53 of each pair of side walls 53 adjacent to each display element. The layer 56 adhesive material serves as a getter to trap loose particles that may unintentionally enter the interior of the display module 20. In the illustrated embodiment, the adhesive material is only applied to the innermost side wall next to each display element. The layer 56 of adhesive material remains exposed (i.e., not covered by any other layer of material) after assembly and throughout the lifetime of the HMD device. In at least some embodiments, the adhesive material is an optically clear adhesive polymer. The adhesive material can be in the form of, for example, double-sided tape or a curable liquid. Preferably an adhesive material that does not produce significant outgassing is used, since outgassing accumulation within the display module 20 can cause blurring of the output images. The layer 56 of adhesive material is completely outside of the optical path from the display elements 37 to the user's eyes, so once a particle is trapped on the adhesive material, the particle is not visible to the user, assuming the particle is small.

### EXAMPLES OF CERTAIN EMBODIMENTS

Certain embodiments of the technology introduced herein are summarized in the following numbered examples:

1. A display module for a near-eye display (NED) device, the display module comprising: a display element to generate an image to be conveyed to an eye of a user of the NED device, the display element having an image-generation surface; a frame having a surface adjacent to the image-generation surface of the display element; a housing that encloses the display element and the frame; and an exposed layer of adhesive material covering at least a portion of said surface of the frame within the housing.

2. The display module of example 1, wherein the adhesive material comprises an optically clear adhesive polymer.

3. The display module of example 1 or example 2, wherein the surface is perpendicular to the image-generation surface of the display element.

4. The display module of any of examples 1 to 3, the frame further having an edge adjacent and perpendicular to the surface, the edge forming part of a mounting region for a passive optical component.

5. The display module of any of examples 1 to 4, wherein the passive optical component is a polarizing beam splitter.

6. The display module of any of examples 1 to 5, the frame further including an aperture adjacent to said surface and shaped to accommodate the image-generation surface of the display element.

7. The display module of any of examples 1 to 6, the frame further including an aperture adjacent to said surface and shaped to accommodate the image-generation surface of the display element.

8. The display module of any of examples 1 to 7, wherein each of the first display element and the second display element is one of: an LCOS, a MEMS or a DLP.

9. The display module of any of examples 1 to 8, further comprising: an optical output port in the housing, and a polarizing beam splitter mounted to the frame and optically coupled to the display element to convey the image along an optical path toward the optical output port.

10. A near-eye display (NED) device comprising: a head fitting by which the NED display device can be worn on the head of a user; a display module coupled to the head fitting, the display module including a display element to generate an image to be conveyed to an eye of a user of the NED device, a frame having a surface adjacent to an image-generation surface of the display element, a housing that encloses the display element and the frame, an optical output port in the housing, and a polarizing beam splitter mounted to the frame and optically coupled to the display element to convey the image along an optical path toward the optical output port; an exposed layer of adhesive material covering at least a portion of said surface of the frame; and a waveguide coupled to the optical output port, to convey the image toward the eye of the user; and a processor to control operation of the NED display device.

11. The NED device of example 10, wherein the adhesive material comprises an optically clear adhesive polymer.

12. The NED device of example 10 or example 11, wherein said surface of the frame is perpendicular to the image-generation surface of the display element.

13. The NED device of any of examples 10 to 12, the flat panel further having an edge adjacent and perpendicular to the surface of the flat panel, the edge forming part of a mounting region for a passive optical component.

14. The NED device of any of examples 10 to 13, wherein the passive optical component is a polarizing beam splitter.

15. The NED device of any of examples 10 to 14, the frame further including an aperture adjacent to said surface and shaped to accommodate the image-generation surface of the display element.

16. The NED device of any of examples 10 to 15, wherein each of the first display element and the second display element is one of: an LCOS, a MEMS or a DLP.

17. A display module for a near-eye display (NED) device, the display module comprising: a first display element to generate a left image to be conveyed to a left eye of a user of the NED device; a second display element to generate a right image to be conveyed to a right eye of the user of the NED device, the left and right images being corresponding image components of a single stereoscopic image; a frame configured to have a passive optical component mounted thereto, the frame including a first aperture that has a size and shape corresponding to an image-generation surface of the first display element, a second aperture that has a size and shape corresponding to an image-generation surface of the second display element, a first flat panel protruding from a location adjacent to the first aperture in a direction perpendicular to the image-generation surface of the first display element, the first flat panel having a first surface adjacent to the first display element and having a first edge adjacent and perpendicular to the first surface, a second flat panel protruding from a location adjacent to the second aperture and to the first flat panel in the direction perpendicular to the image-generation surface of the first display element, the second flat panel having a second surface adjacent to the second display element and having a second edge adjacent and perpendicular to the second surface, wherein the first and second edges of the first and second flat panels, respectively, collectively form at least part of a mounting surface for the passive optical component; a polarizing beam splitter mounted to the first edge and the second edge; a first exposed layer of adhesive material covering at least a portion of the first surface of the first flat panel adjacent to the first display element; a second exposed layer of adhesive material covering at least a portion of the second surface of the second flat panel adjacent to the second display element; and a housing that encloses the first and second display elements, the frame, the polarizing beam splitter, and the first and second exposed layers of adhesive material.

18. The display module of example 17, wherein the first edge of the first flat panel and the second edge of the second flat panel are at an acute angle relative to the image-generation surfaces of the first and second display elements.

19. The display module of example 17 or example 18, wherein the adhesive material comprises an optically clear adhesive polymer.

20. The display module of any of examples 17 to 19, wherein each of the first display element and the second display element is one of: an LCOS, a MEMS or a DLP.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A display module for a near-eye display (NED) device, the display module comprising:
a display element to generate an image to be conveyed to an eye of a user of the NED device, the display element having an image-generation surface;
a frame having a surface adjacent to the image-generation surface of the display element;
a housing that encloses the display element and the frame; and
an exposed layer of adhesive material covering at least a portion of said surface of the frame within the housing.

2. The display module of claim 1, wherein the adhesive material comprises an optically clear adhesive polymer.

3. The display module of claim 1, wherein the surface is perpendicular to the image-generation surface of the display element.

4. The display module of claim 1, the frame further having an edge adjacent and perpendicular to the surface, the edge forming part of a mounting region for a passive optical component.

5. The display module of claim 4, wherein the passive optical component is a polarizing beam splitter.

6. The display module of claim 1, the frame further including an aperture adjacent to said surface and shaped to accommodate the image-generation surface of the display element.

7. The display module of claim 1, the frame further including an aperture adjacent to said surface and shaped to accommodate the image-generation surface of the display element.

8. The display module of claim 1, wherein each of the first display element and the second display element is one of: an LCOS, a MEMS or a DLP.

9. The display module of claim 1, further comprising:
an optical output port in the housing, and a polarizing beam splitter mounted to the frame and optically coupled to the display element to convey the image along an optical path toward the optical output port.

10. A near-eye display (NED) device comprising:
a head fitting by which the NED display device can be worn on the head of a user;
a display module coupled to the head fitting, the display module including
a display element to generate an image to be conveyed to an eye of a user of the NED device,
a frame having a surface adjacent to an image-generation surface of the display element,
a housing that encloses the display element and the frame,
an optical output port in the housing, and
a polarizing beam splitter mounted to the frame and optically coupled to the display element to convey the image along an optical path toward the optical output port;
an exposed layer of adhesive material covering at least a portion of said surface of the frame; and
a waveguide coupled to the optical output port, to convey the image toward the eye of the user; and
a processor to control a function of the NED display device.

11. The NED device of claim 10, wherein the adhesive material comprises an optically clear adhesive polymer.

12. The NED device of claim 10, wherein said surface of the frame is perpendicular to the image-generation surface of the display element.

13. The NED device of claim 12, the flat panel further having an edge adjacent and perpendicular to the surface of the flat panel, the edge forming part of a mounting region for a passive optical component.

14. The NED device of claim 13, wherein the passive optical component is a polarizing beam splitter.

15. The NED device of claim 10, the frame further including an aperture adjacent to said surface and shaped to accommodate the image-generation surface of the display element.

16. The NED device of claim 10, wherein each of the first display element and the second display element is one of: an LCOS, a MEMS or a DLP.

17. A display module for a near-eye display (NED) device, the display module comprising:
a first display element to generate a left image to be conveyed to a left eye of a user of the NED device;
a second display element to generate a right image to be conveyed to a right eye of the user of the NED device, the left and right images being corresponding image components of a single stereoscopic image;
a frame configured to have a passive optical component mounted thereto, the frame including
a first aperture that has a size and shape corresponding to an image-generation surface of the first display element,
a second aperture that has a size and shape corresponding to an image-generation surface of the second display element,
a first flat panel protruding from a location adjacent to the first aperture in a direction perpendicular to the image-generation surface of the first display element, the first flat panel having a first surface adjacent to the first display element and having a first edge adjacent and perpendicular to the first surface,
a second flat panel protruding from a location adjacent to the second aperture and to the first flat panel in the direction perpendicular to the image-generation surface of the first display element, the second flat panel having a second surface adjacent to the second display element and having a second edge adjacent and perpendicular to the second surface,
wherein the first and second edges of the first and second flat panels, respectively, collectively form at least part of a mounting surface for the passive optical component;
a polarizing beam splitter mounted to the first edge and the second edge;
a first exposed layer of adhesive material covering at least a portion of the first surface of the first flat panel adjacent to the first display element;
a second exposed layer of adhesive material covering at least a portion of the second surface of the second flat panel adjacent to the second display element; and
a housing that encloses the first and second display elements, the frame, the polarizing beam splitter, and the first and second exposed layers of adhesive material.

18. The display module of claim 17, wherein the first edge of the first flat panel and the second edge of the second flat panel are at an acute angle relative to the image-generation surfaces of the first and second display elements.

19. The display module of claim 17, wherein the adhesive material comprises an optically clear adhesive polymer.

20. The display module of claim 17, wherein each of the first display element and the second display element is one of: an LCOS, a MEMS or a DLP.
